(19) United States
(12) Patent Application Publication
(10) Pub. No.: US 2017/0147523 A1
(43) Pub. Date: May 25, 2017

(54) ROUTING APPARATUS AND ROUTING METHOD AND COMPUTER SYSTEM AND PROGRAM AND STORAGE MEDIUM STORING PROGRAM

(71) Applicant: AKIB SYSTEMS INC., Tokyo (JP)

(72) Inventors: Hideto NAKAYAMA, Tokyo (JP); Kentaro IWASAWA, Tokyo (JP)

(73) Assignee: AKIB SYSTEMS INC., Tokyo (JP)

(21) Appl. No.: 15/423,254

(22) Filed: Feb. 2, 2017

Related U.S. Application Data
(63) Continuation of application No. PCT/JP2014/070579, filed on Aug. 5, 2014.

(51) Int. Cl. G06F 13/40; G06F 13/28; G06F 13/42

(52) U.S. Cl. CPC G06F 13/4022; G06F 13/4282; G06F 13/28; G06F 2213/0026

(57) ABSTRACT

A technique is realized that provides a routing operation while using a Point-to-Point communication method as in PCI-Express. A routing address is inserted to a data portion in TLP of PCI-Express. When a routing unit connected to a computer receives TLP from the computer, then a routing switch reads the routing address of a data portion of this TLP to refer to a routing table to determine a slot to which the TLP should be sent. Based on this determination, the routing switch sends the TLP to the predetermined slot. Thus, the routing based on the routing address can be executed.

### TECHNICAL FIELD

The present invention relates to a routing apparatus and a routing method. In particular, the invention relates to a technique to realize the routing to communicate with a plurality of parties while using a Point-to-Point communication means.

### BACKGROUND

Today, PCI-Express is being widely used as an internal slot of a computer. This PCI-Express provides high-speed communication. PCI-Express2.0 (Gen2) for example has a physical bandwidth per one lane of 5.0 Gbps in one direction and has a data transfer speed of 500 Mbyte/sec. Thus, the PCI-Express has been recognized as a high speed internal slot. PCI-Express3.0 (2010) having a higher speed, with a physical bandwidth of 8.0 Gbps in one direction, has been established. Currently, PCI-Express4.0 (Gen4) (having a speed two times higher than Gen3) has been considered.

General Configuration of Computer Using PCI-Express

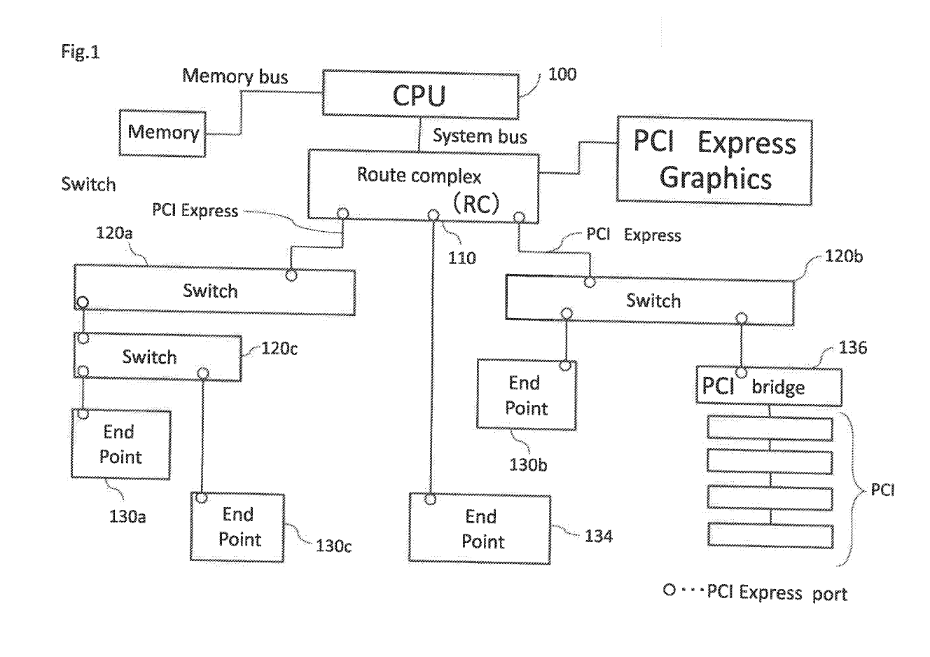

FIG. 1 illustrates an example of a computer including PCI-Express internal port (which may be called “internal slot” or “internal bus” for example and also may be called “expansion slot” or “expansion bus” based on the meaning).

When the PCI-Express is used, a CPU 100 is firstly connected to a route complex (hereinafter also may be simply referred to as RC) 110. The RC 110 includes a plurality of PCI-Express ports and also may include switches 120a, 120b, and 120c so as to cope with a required port number. These switches 120 may be connected in a multistage manner in order to cope with a required port number (see FIG. 1).

An I/O device is called an end point and is connected to a switch 120a or a switch 120b for example. Various end points exist such as general PCI-Express end points 130a, 130b, and 130c directly connected to the PCI-Express port of the switch 120 and a route complex end point 134 connected to the RC 110 for example.

In FIG. 1, ∘ represents a PCI-Express port.

The PCI-Express port also can include a so-called bridge to perform a protocol conversion for other buses. In the example of FIG. 1, a PCI bridge 136 is shown to perform a protocol conversion for a PCI bus as a conventional bus for example. This bridge can provide the conversion from the PCI-Express to the PCI.

FIG. 1 is drawn to include the PCI-Express at the center. In an actual case, a memory (see FIG. 1) and a storage means such as a hard disk are also included. Although not shown, a PCI-Express graphics (see FIG. 1) is connected to a display apparatus. A mouse and a keyboard (not shown) for example are connected to a system bus (see FIG. 1) via a predetermined interface.

As is clear from FIG. 1 and the above description, this PCI-Express is a so-called p-p (point-to-Point) communication path and performs Point-to-Point communication. Thus, a switch 120 is required to connect a plurality of I/O devices as shown in FIG. 1 (see FIG. 1).

However, it would be convenient if this PCI-Express has a routing function. The present invention has been made based on such a concept. The main objective is to provide a technique to realize a routing function while using the PCI-Express.

Prior Art Document

Patent literature 1 shown below discloses a system and a method to perform the routing on a wireless network. In particular, a technique is disclosed that is characterized in that a parent unit prepares a spanning tree of a Point to Point wireless network to thereby determine a route.

Patent literature 2 shown below discloses an algorithm to appropriately provide, when a Secondary Port is included using a PCI-PCI bridge, a routing so that all devices can be detected by BIOS during the configuration.

### CITATION

### Patent Literature

[Patent literature 1]

Japanese Unexamined Patent Application Publication No. 2002-077194

[Patent literature 2]

Japanese Unexamined Patent Application Publication No.2002-207668

### SUMMARY OF THE INVENTION

### Technical Problem

As described above, the PCI-Express is a specification performing the Point-to-Point communication in principle. Thus, the connection of many devices requires many switches, which tends to cause a complicated configuration.

It would be convenient if this PCI-Express has the routing function. However, no such suggestion or technique leas been conventionally provided.

The present invention has been made in view of the background as described above. The main objective of the invention is to provide a technique to realize the routing function while using the PCI-Express.

### Means for Solving the Problem

As described above, the PCI-Express is a specification to perform the Point-to-Point communication. Thus, the PCI-Express does not have a routing mechanism in principle. To solve this, the inventors of this application has reached, through keen research, an idea that the routing is performed by including routing information in a payload part of a PCI-Express packet (TLP).

Specifically, the invention of this application uses a configuration as described below.

(1) The present invention has been made in view of the above disadvantage. The invention provides a routing method of using a routing apparatus provided between a computer and the other plurality of I/O devices to use a communication method for performing Point-to-Point communication to perform communication between the computer and the other plurality of I/O devices, characterized in comprising: a step of allowing the computer to store a predetermined routing address in a data portion of a packet as a communication target of the communication method to send the packet; and a step of allowing the routine apparatus to extract the routing address in the sent packet to send the packet to the I/O device as a destination shown by the routing address.

(2) The present invention also provides a routing method, characterized in that: in the routing method according to the above (1), the routing address is an address unique to the I/O device.

(3) The present invention also provides a routing method, characterized in that: in the routing method according to the above (1), the routing address is an address allocated by the computer to the I/O device.

(4) The present invention provides a program for allowing the computer to execute the routing method according to the above (1), characterized in that: the address of the I/O device is described as XXX@YYY, wherein the XXX means the routing address and the YYY means the address of the routing apparatus in the computer.

(5) The present invention provides a storage medium storing therein the program for allowing the computer to execute the routing method according to the above (1), the program characterized in that: the address of the I/O device is described as XXX@YYY, wherein the XXX means the routing address and the YYY means the address of the routing apparatus in the computer.

(6) In order to solve the above disadvantage, the present invention provides a method of using a routing apparatus provided between a computer and other plurality of electronic devices to use a communication method for performing Point-to-Point communication to perform communication between the computer and the other plurality of electronic devices, characterized in comprising: a step of allowing the computer to store, in a data portion of a packet as a communication target of the communication method, a routing address showing a target electronic device as a communication partner and an internal address of the target electronic device to send the packet; and a step of allowing the routing apparatus to extract the routing address in the sent packet to send the packet including an internal address of the target electronic device to the target electronic device as a destination shown by the routing address.

(7) The present invention provides a program to allow the computer to execute the routing method according to the above (6), characterized in that: an address in the target electronic device is described as XXX@ZZZ, wherein the ZZZ means the routing address showing the target electronic device and the XXX means an internal address in the target electronic device.

(8) The present invention provides a storage medium storing therein a program for allowing the computer to execute the routing method according to the above (6), the program characterized in that: an address, in the target electronic device is described as XXX@ZZZ, wherein the ZZZ means the routing address showing the target electronic device and the XXX means an internal address in the target electronic device.

(9) In order to solve the above disadvantage, the present invention provides a computer system comprising a computer, a routing apparatus connected to the computer, and one or more I/O devices connected to the routing apparatus, characterized in that: the routing apparatus comprises a connector for providing the connection to the computer by a Point-to-Point communication method; a plurality of slots that may be connected to the I/O devices; and a routing switch for extracting a routing address stored in a data portion of a packet as a communication target of the communication method sent from the computer via the connector to send the packet to the slot specified by the routing address. When the computer stores the routing address in a data portion of a packet as a communication target of the communication method and sends the packet to the routing apparatus via the connector, then the routing apparatus extracts the routing address stored in the data portion of the packet as a communication target of the communication method and sends the packet to the slot specified by the routing address.

(10) According to the present invention, the computer system according to the above (9) is characterized in that: the routing apparatus includes a routing table recording a correspondence relation between the routing address and a slot number corresponding thereto, the routing switch searches a routing address in the packet from the routing table to determine, based on the found correspondence relation, the slot number to be sent and sends the packet to a slot having the determined number.

(11) According to the present invention, the computer system according to the above (10) is characterized in that: the routing switch reads, when the any slot is connected to the I/O device, an address unique to the I/O device from the I/O device to register, in the routing table, the unique address and the slot number connected to the I/O device and the routing switch uses the unique address as a routing address.

In this embodiment for example, this unique address shows a MAC address for example.

(12) According to the present invention, a method of storing the correspondence relation in the routing table in the computer system according to the above (10) is characterized in that: the method includes a step of allowing the routing switch to read, when the any slot is connected to the I/O device, an address unique to the I/O device from the I/O device and registers, in the routing table, the unique address and the slot number connected to the I/O device, the routing switch using the unique address as a routing address.

The unique addresses of the above (11) and (12) may be any address so long as the addresses are an address unique to this I/O device. For example, a MAC address for example is shown in this embodiment.

(13) Also according to the present invention, the computer system according to the above (10) is characterized in that: the routing switch allocates, when the any slot is connected to the I/O device’, a predetermined address to the I/O device to register, in the routing table, the allocated address and the slot number connected to the I/O device and the routing switch uses the allocated address as a routing address.

This allocated address also may be preferably set to a connected slot in advance.

(14) Also according to the present invention, a method of storing the correspondence relation in the routing table in the computer system according to the above (10) is characterized in that: the method includes a step of allowing the routing switch to allocate, when the any slot is connected to the I/O device, a predetermined address to the I/O device to register, in the routing table, the allocated address and the slot number connected to the I/O device, the routing switch using the allocated address as a routing address.

These allocated address of the above (13) and (14) also may be preferably set to a connected slot in advance for example.

(15) Also according to the present invention, the routing apparatus used in the computer system according to the above (9) is a routing apparatus, characterized in comprising; a connector for providing the connection to the computer by a Point-to-Point communication method; a plurality of slots that may be connected to the I/O devices; and a routing switch for extracting a routing address stored in a data portion of a packet as a communication target of the communication method sent from the computer via the connector to send the packet to the slot specified by the routing address. When the computer stores the routing address in a data portion of a packet as a communication target of the communication method and sends the packet to the routing apparatus via the connector, then the computer extracts the routing address stored in the data portion of the packet as a communication target of the communication method and sends the packet to the slot specified by the routing address.

(16) Also according to the present invention, the routing apparatus according to the above (15) is a routing apparatus is characterized in: further including a routing table recording a correspondence relation between the routing address and a slot number corresponding thereto. The routing switch searches a routing address in the packet from the routing table to determine, based on the found correspondence relation, the slot number to be sent and sends the packet to a slot having the determined number.

### Advantageous Effects of Invention

As described above, according to the present invention, a Point-to-Point communication method (e.g., PCI-Express) is used to bury a routing address in a data portion of the packet, thus providing a routing operation,

### BRIEF DESCRIPTION OF EMBODIMENTS

FIG. 1 illustrates an example of a general configuration using PCI-Express.

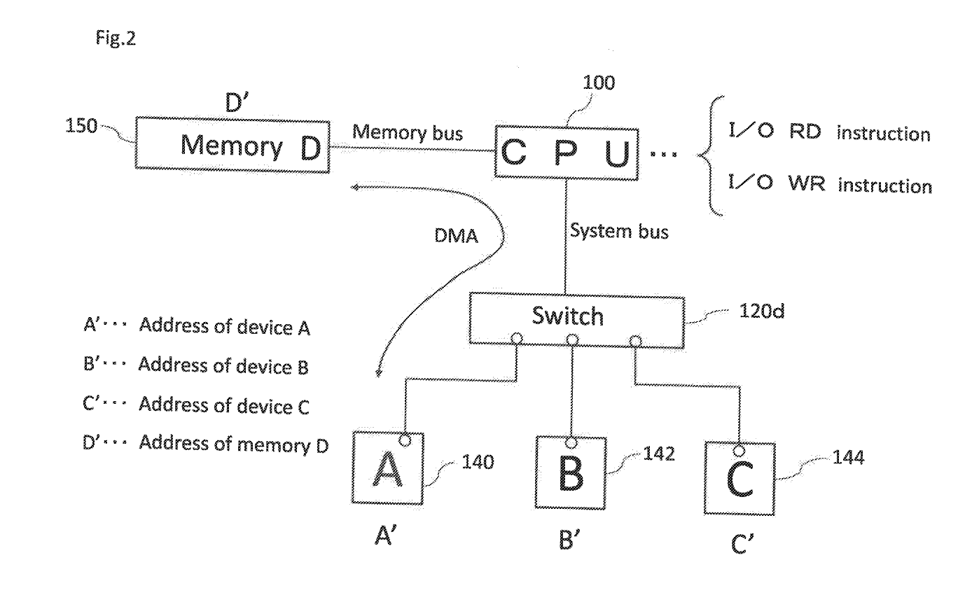

FIG. 2 illustrates the access from a CPU to an I/O device.

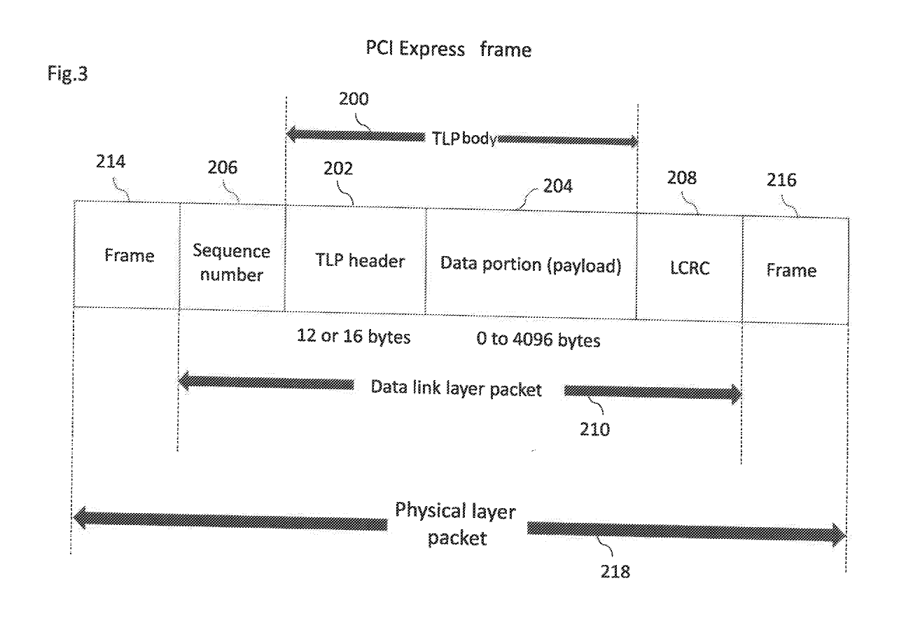

FIG. 3 illustrates the outline of a TLP format.

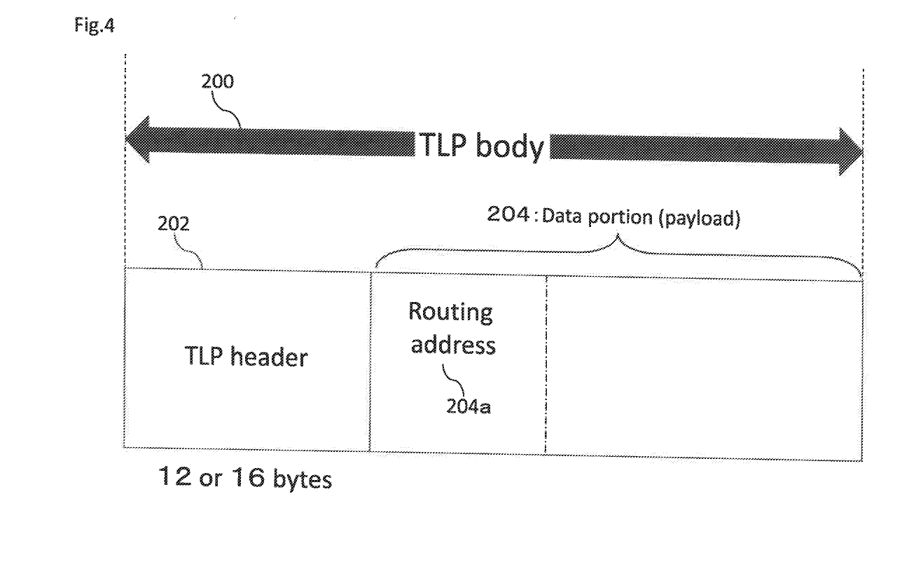

FIG. 4 illustrates a routing address buried in TLP.

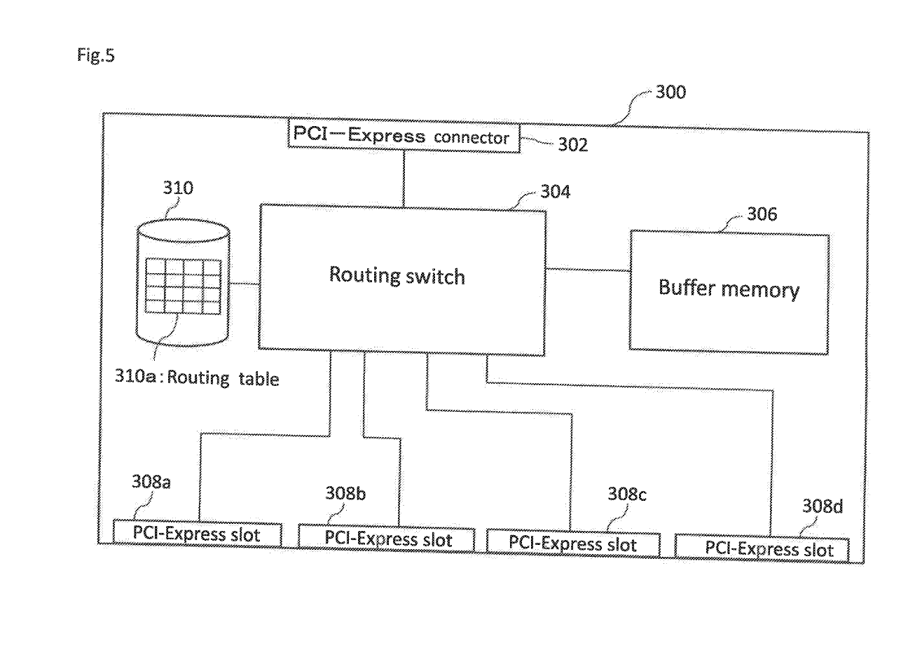

FIG. 5 is a configuration block diagram illustrating the configuration of a routing unit 300.

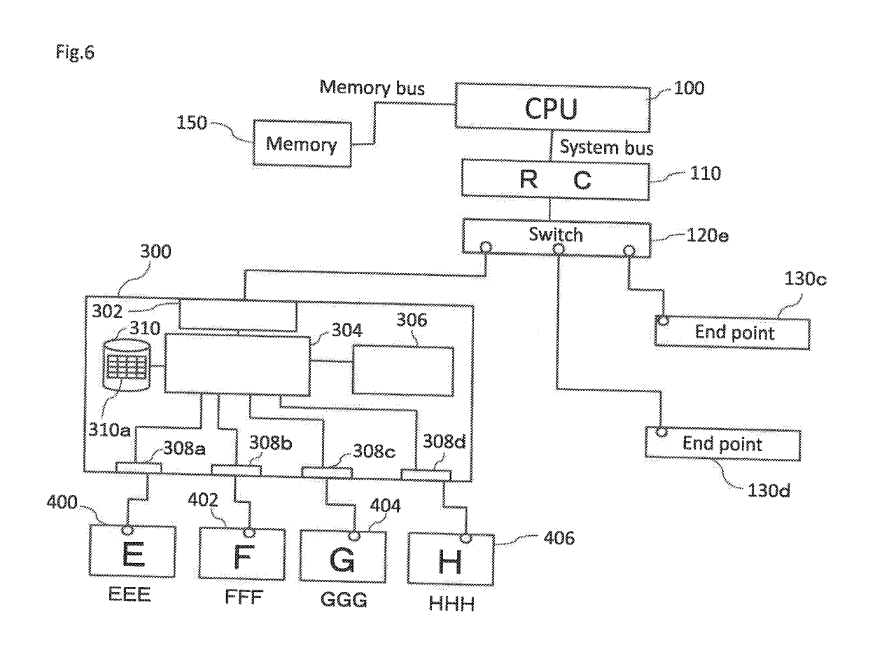

FIG. 6 illustrates the configuration of a computer connected to the routing unit 300.

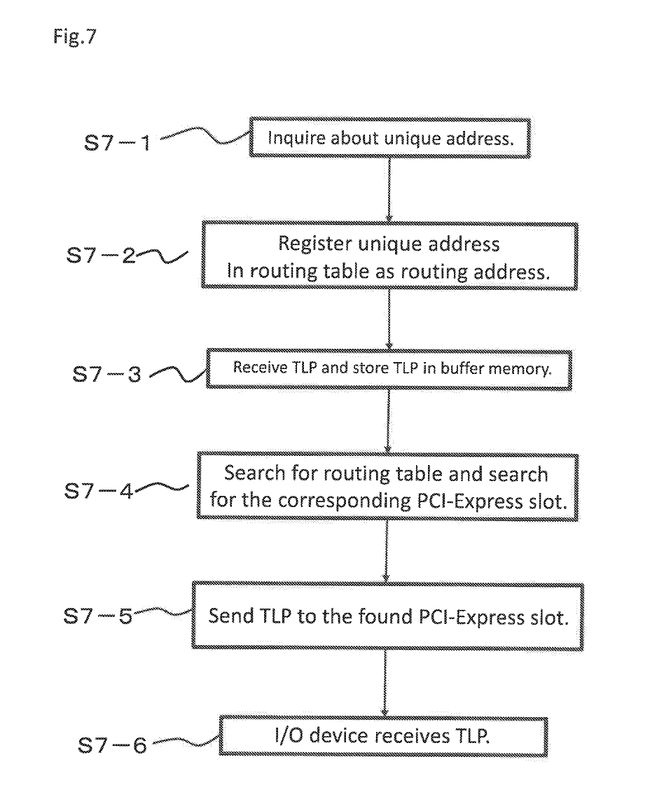

FIG. 7 is a flowchart illustrating an operation example of the routing unit 300.

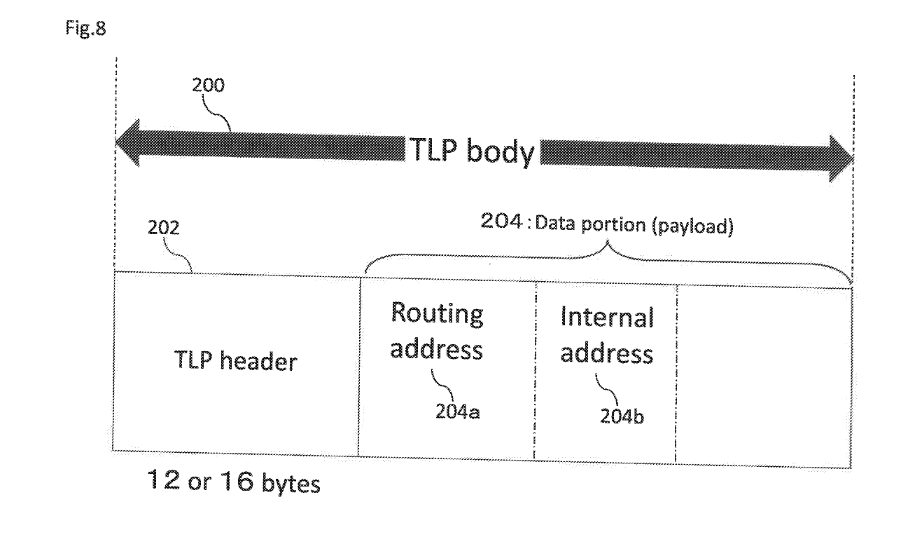

FIG. 8 illustrates the TLP in which a data portion 204 stores a routing address 204a and an internal address 204b for example.

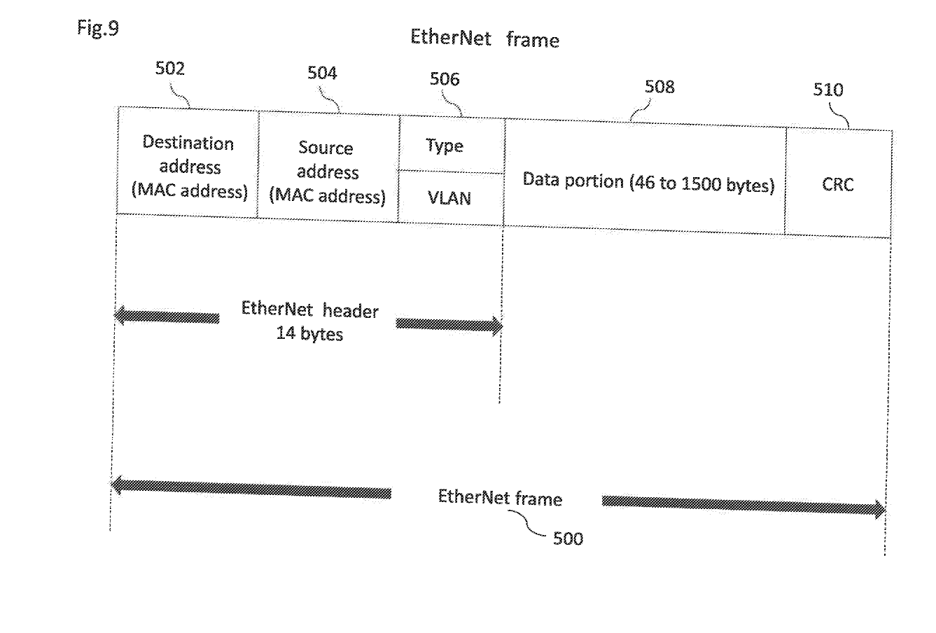

FIG. 9 illustrates the outline of an example of an EtherNet® frame 500.

### DESCRIPTION OF EMBODIMENTS

The following section will describe a preferred embodiment of the present invention based on the drawings.

1. Access to I/O device using PCI-Express

First, the following section will describe the concept of the access to an I/O device using PCI-Express. FIG. 2 illustrates the access to an I/O device using PCI-Express and schematically illustrates a CPU and the I/O device for example in a computer.

First, the CPU 100 accesses an I/O device A140, an I/O device, B142, or an I/O device C144 for example based on I/O instructions. These I/O instructions include I/O RD instruction for a reading operation and an I/O WR instruction for a writing operation for example.

Based on these instructions, the CPU 100 performs data reading or writing operation to the I/O device A140, the I/O device B142, or the I/O device C144 for example via a system bus (see FIG. 2) through a switch 120d.

In the operation as described above, which I/O device is accessed is specified by the address of an I/O instruction. This address allows the switch 120d to determine which I/O device is accessed to perform a reading or writing operation to an I/O device specified by the address intended by the I/O instruction. In FIG. 2, the address of the I/O device A140 is represented by A′. Similarly, the address of the I/O device B142 is represented by B′. The address of the I/O device C144 is represented by C′ (see FIG. 2).

Due to reasons such as a higher speed, the access to an I/O device is also frequently performed by DMA (see FIG. 2). In this case, the access to a memory D150 is also performed. The access to the memory D150 is similarly carried out as in the above I/O instruction by specifying the memory by the address. In FIG. 2, the address of the memory D150 is represented by D′.

The address D′ of the memory is basically the same as the address of the I/O device. The access to the memory 150 is carried out via a memory bus (see FIG. 2).

The PCI-Express corresponds to a preferred example of a claimed Point-to-Point communication method.

2. Regarding TLP of PCI-Express

Next, the following section will describe a transaction layer palette (TLP) used in the PCI-Express.

Transmission Side

In the PCI-Express, at the transmission side, depending on a request from a software layer, tt TLP (Transaction Layer Packet) is generated in a transaction layer.

FIG. 3 illustrates the outline of the format of the transaction layer Packet (TLP). As shown in FIG. 3, a TLP body 200 is composed of a TLP header 202 and a data portion 204. ECRC for example also may be added in addition to them but is omitted in this description. The TLP header 202 also may be simply called as a header 202.

The data portion 204 is also frequently called as a “payload”. A data portion of 256 k bytes is generally widely used. The data portion can be increased up to 4 kbytes (4096 bytes) according to the specification. However, substantially no such devices supporting this have been known. Generally, the data portion is frequently 256 bytes.

This TLP body 200 in the transaction layer is given to a data link layer at the transmission side. At the data link layer, a sequence number 206 and a LCRC 208 are added, thereby forming a data link layer packet 210 (see FIG. 3). This data link layer packet 210 is given from the data link layer to a physical layer.

This data link layer packet 210 in the physical layer is added with a start frame 214 and an end frame 216 and a physical layer packet 208 is configured.

As described above, the PCI-Express is based on the Point-to-Point communication and thus does not have a routing concept. Thus, the above TLP does not include an address or similar data.

Therefore, an operation is generally performed in which, based on the address in the I/O instruction of the computer, a hardware such as the switch 120 sends the above TLP to a predetermined address.

According to the present invention, a routing function is added to the PCI-Express having no such routing so that TLP transmission can be done more widely. The detailed mechanism thereof will be described in detail later.

Recention Side

At the reception side, in the physical layer, the data link layer packet 210 excluding the start frame 214 and the end frame 216 is generated and sent to the data link layer. After the data link layer receives the above send data (the data link layer packet 210) from the physical layer, the data link layer confirms the sequence number 206 and the LCRC 208 and gives the TLP body 200 excluding them to the transaction layer.

At the reception side, the transaction layer analyzes the data received from the data link layer (the TLP body 200) and extracts data depending on a command type and gives the data to the software layer.

The TLP header 202 stores therein the command type for example.

3. Embodiment 1: Introduction of Routing Address to Data Portion (Payload) (Principle of the Present Invention)

As described in the prior art section, the PCI-Express originally does not include a routing function.

(1) Introduction of routing address to data portion

To solve this, according to this embodiment 1, a new routing address is introduced into the data portion 204 (payload) (see FIG. 2) in the packet (TLP) of the PCI-Express and is used for a routing operation. This is a characteristic matter in the present invention and this embodiment. This mechanism can be used to introduce the routing operation to the PCI-Express.

As described above, the introduction of a new routing address into the data portion 204 (payload) can introduce the routing technique without requiring any change in the PCI-Express mechanism such as an existing TLP.

How this is provided is shown in FIG. 4. FIG. 4 illustrates a TLP 200 used in this embodiment. As shown in this drawing, the routing address 204a is inserted to the data portion (payload) 204. This is a characteristic matter in this embodiment. The routing address 204a inserted to this data portion allows a routing operation.

(2) Position and Length of Routing Address

In FIG. 4, the routing address is placed at the beginning of the data portion 204. However, the routing address may be placed at any appropriate position depending on the format of used data. The routing address also may be placed at the end of the data portion 204.

The length of the routing address may have various values depending on an application. According to computer architectures in recent years, 32 bit or 64 bit systems are frequently used. Thus, a 32 bit length or 64 bit length routing address in accordance with them also may be preferably used. However, a bit length having other lengths also may be preferably used in particular independent of the system hit length.

4. Embodiment 1: Software (Program)

From the upper side of software (hereinafter also may be referred to as program), a so-called I/O instruction is used to provide input/output to the I/O device. Conventionally, the I/O device was specified based on the address in the I/O instruction. In an actually case, during this, a so-called device list is referred to and a desired address is also frequently obtained.

(1) Use of Routing Address

On the other hand, in this embodiment 1, the routing address 204a is inserted to the data portion 204 in the TLP 200. The I/O device can be specified by inserting a desired destination address to a data portion in the I/O instruction as described above. Thus, the I/O device address can be specified by a so-called data portion (also may be frequently called as operand) of the instruction, thus easily specifying the I/O device.

(2) Representation by XXX@YYY Method

In this embodiment 1 in particular, it is suggested that XXX@NYY is represented as a new representation of the I/O address on the program.

(2a) in this representation, YYY means a conventional I/O address but is not distinguished from the memory address on the architectures of many computers. Thus, the I/O address is substantially the same as the memory address. The computer architecture in recent years has a 32 bit or 64 bit system. Thus, this YYY is represented by 32 bits or 64 bits in many cases. YYY means an address of a routing unit in the computer.

(2b) The above XXX, means the routing address suggested in this embodiment 1. As described above, this routing address 204a can be configured by an arbitrary bit length. A different bit length or configuration is determined depending on an application to be used. For example, an 8 byte length of 64 bits may be preferably configured or a 6 byte length (48 bits) or a 4 byte length (32 bits) also may be configured. This may be determined depending on a system or may be determined depending on an application to be used.

(2c) As described later, a program using, such a representation method is described in claims. By using the representation method as described above, a program can be prepared in a more easy-to-understand manner and an effect is provided according to which the program can be read more easily. A storage medium storing therein a program using the representation method as described above is described in claims. The storage medium storing therein a program using the representation method as described above can supply the above program to a predetermined computer and allows a computer to perform the above-described routing.

5. Routing Unit

As described above, in this embodiment 1, it has been described that (a) a part of the data portion 204 is used as a routing address on software; and (b) XXX@WYY is represented as a method to represent the I/O device address for example.

The following section will, describe a routing unit that is a device to perform a routing operation using them.

The routing unit 300 corresponds to a preferred example of the claimed routing apparatus. This routing unit 300 has a configuration basically connected between a computer (e.g., the CPU 100) and an I/O device (see FIG. 6 described later for example).

### (1) Routing Unit

FIG. 5 is a configuration block diagram illustrating the configuration of the routing unit 300 performing a routing operation in this embodiment 1. As shown in this drawing, the routing unit 300 includes a PCI-Express connector 302 that inputs a PCI-Express signal and that inputs a PCI Express signal (see FIG. 3) from the exterior.

As described above, the routing, unit 300 is basically an apparatus connected to a computer (e.g., the CPU 100). Specifically, the routing unit 300 receives a PCI-Express packet (TLP) from the computer in this PCI-Express connector 302.

### (2) Routing Switch

A routing switch 304 in the routing unit 300 accumulates the inputted PCI-Express signal once in a buffer memory 306. Next, the routing switch 304 extracts the PCI-Express signal once accumulated in the buffer memory (i.e., the routing address 204a in the data portion 204 in TLP). Then, the routing switch 304 sends the TLP(see FIG. 3) to the PCI-Express slot 308 specified by the routing address 204a (any of a to d). As shown in FIG. 4, the routing unit 300 includes PCI-Express slots 308a, 308b, 308c, and 308d connected to an I/O external device. The PCI-Express slots 308a, 308b, 308c, and 308d are connected to predetermined I/O devices, respectively.

The correspondence relation between the routing address 204a and the corresponding PCI-Express slot 308 (a to d) is preferably set in advance and is preferably stored on a memory 310 in advance as a routing table 310a.

### (3) Routing Table

The routing table 310a shows the correspondence relation between the routing address 204a and the corresponding PCI-Express slot 308 (a to d). It is considered that the contents thereof may be firstly determined and registered. Such data is realized by allowing the computer (CPU) to send the data to the routing unit 300 to allow the routing switch 304a having received this data to store the contents in the routing table 310a.

(3a)

Alternatively, when a predetermined I/O device is connected to a predetermined PCI-Express slot, the routing switch 304 reads the unique address of the I/O device connected to the slot to store, in the routing table 310a, a pair of the unique address and the PCI-Express slot (or slot number) connected to the I/O device.

When the connection is established, the registration as described above may be preferably performed quickly or may be also performed by the connection to the I/O device preferably followed by the reboot of the computer. In the case of the reboot, the contents of the routing table 310a are preferably registered as a part of the operation of a process of preparing a device list.

(3b)

As described above, if the I/O device has a unique address, the unique address is preferably used as a routing address, which corresponds to XXX in the above-described XXX@YYY.

In this case, YYY means the address of the routing unit 300. This address is an internal address of the computer connected to the routing unit 300 (which is an I/O address and is also a memory address). This address YYY is accessed by the CPU 100 of the computer.

The unique address of the I/O device is generally frequently read by a predetermined command and is read by the routing switch 304. Some I/O devices require, from the security viewpoint, a user to (read the address in the operating manual) to input the address manually. In any case, the unique address is stored in the routing table 310a.

(3c)

In the above description, a case where the unique address of the I/O device is used as a routing address has been described. However, in the case of a device not including a unique address, the address is also preferably allocated automatically from the computer side.

In this case, a method of “dynamically” allocating the address from the (3c-1) computer is also preferred or another method of setting a unique “fixed” address to the (3c-2) PCI-Express slot in advance is also preferred. The fixed address means, m the case of FIG. 5 for example, “AXX” of the address of the PCI-Express slot 308a and “BXX” of the address of the PCI-Express slot 308b for example.

The “dynamic” or “fixed” allocation of the address as described above may be performed even when the I/O device has a unique address. The reason is that there may be a case where the allocated address is desirably used in a “dynamic” or “fixed” manner instead of using the unique address of the I/O device.

(3d)

The memory 310 storing therein the routing table 310a is shown separately from the buffer memory 306 (see FIG. 5). However, from the hardware viewpoint, the memory 310 also may be formed on the same memory apparatus.

### (1) Configuration and Address and the Representation of the Address

FIG. 6 is a configuration diagram illustrating a case where the routing unit 300 shown in FIG. 5 is connected to a general computer. As shown in FIG. 6, the I/O device E400, the I/O device F402, the I/O device G404, and the I/O device H406 are connected via the routing unit 300. In FIG. 6, the internal configuration of the routing unit 300 is not illustrated in full but the internal configuration is similar to that of FIG. 5.

The computer shown in FIG. 6 is configured as in FIG. 1 so that the CPU 100 is provided at the center and this CPU 100 is connected to a memory 150 via a memory bus. The CPU 100 is also connected to the switch 120e via an RC (route complex) 110. The switch 120e is connected to an end point 130c for example and the routing unit 300. The routing unit 300 has four PCI-Express the slots 308a, 308b, 308c, and 308d (see FIG. 5 and FIG. 6). The respective slots are connected to the I/O device E400, the I/O device F402, the I/O device G404, and the I/O device H406, respectively. The I/O device E400 the I/O device F402, the I/O device G404, and the I/O device H406 have routing addresses represented as “EEE”, “FFF”, “GGG”, and “HHH”, respectively (see FIG. 6).

In order to access the end point 130c for example based on an I/O instruction from the CPU 100, the access destination is specified based on the address (I/O address) in the I/O instruction. As described above, the memory is similarly accessed based on the memory address specified by the address.

In order to access the I/O device E400 from the CPU 100 on the other hand, an I/O instruction including the routing address in a data portion is executed. The address shown by this I/O instruction (I/O address) is the address of the routing unit 300.

For example, in order to access the I/O device E400, the address of the I/O device E400 is preferably represented, from the program viewpoint, as EEE@YYY.

In this representation, EEE shows the routing address of the I/O device E400 and “YYY” shows the address of the routing unit 300 and the internal address of this computer (32 bits or 64 bits).

Thus, this embodiment suggests a program to specify the I/O device based on the “EEE@YYY” type representation method as described above. This embodiment also suggests a storage medium storing therein this program (e.g., DVD-ROM, a hard disk, various semiconductor memories (e.g., USB memory, memory card, IC card)). The use of these programs allows an easy description of the program and a clear representation of a specified I/O device, thus providing an effect according to which the program can be read easily. By using various storage media storing therein this program, the routing operation can be performed while using the PCI-Express in a predetermined computer.

This “YYY” is an address specified by the I/O instruction executed by the CPU (I/O address). As a result, TLP for example is sent to the routing unit 300 specified by the address “YYY”. The “YYY” is the address of the routing unit 300 as described above.

On the other hand, “DEE” is stored in the data portion on the TLP of the PCI-Express. Specifically, this “EEE” is the routing address 204a in the above-described FIG. 4.

### (2) Operation Example

### Routing Unit

The following section will describe the operation example of the routing unit 300 based on the flowchart of FIG. 7. Based on this flowchart, the following section will generally explain operations including the update of the contents of the routing table 310a to the operation after the reception of TLP by the routing unit 300.

(Step 1)(step S7-1 of FIG. 7)

First, when the I/O device E400 (for example) is newly connected to the routing unit 300, then the routing switch 304 detects this and inquires the I/O device E400 about an unique address retained therein (inquiry).

In response to this inquiry, the I/O device E400 returns the unique address “EEE” retained therein.

(Step 2)(step S7-2 of FIG. 7)

In order to use the returned unique address as a routing address, the routing switch 304 stores a pair of the PCI-Express slot 308a and this unique address “EEE” in the routing table 310a.

As a result, the:pair of the unique address “EEE” and the PCI-Express slot 308a is inputted and registered as an entry in the routing table 310a.

The unique address is registered and stored in the routing table 310a similarly for the I/O device F402, the I/O device G404, and the I/O device H406 for example.

(Step 3)(step S7-3 of FIG. 7)

Next, when a predetermined TLP is sent from the switch 120e (see FIG. 6) to the routing unit 300, through the PCI-Express connector 302, the routing switch 304 (see FIG. 5) having received the above TLP stores the TLP once in the buffer memory 306.

The following description will be made based on an assumption that the routing address 204a in this TLP is “EEE” as described above.

(Step 4)(step S7-4 of FIG. 7)

Next, the routing switch 304 extracts the routing address 204a of the data portion 204 in the above TLP stored in the buffer memory 306 (i.e., “EEE”) and searches this routing address from the routing table 310a in the memory.

As a result, the routing switch 304 can find the “EEE” from the routing table 310a and can find the corresponding PSI-Express slot 308a from the entry and can know a PCI-Express slot through which the TLP should be sent.

(Step 5)(step S7-5 of Fig, 7)

Next, the routing switch 304 sends the above TLP extracted from the buffer memory 306 to the above known destination (i.e., the PCI-Express slot 308a).

(Step 6)(step S7-6 of FIG. 7)

Next, the I/O device E400 connected to PCI-Express slot 308a can receives the sent TLP to thereby receive the I/O instruction from the CPU 100. As a result of the operation as described above, the CPU 100 can send the I/O instruction to the desired I/O device E400.

As described above, in this embodiment, the routing address 204a is stored in the data portion 204. Thus, the communication specification having no routing function also can realize the routing operation.

In the example of the flowchart of FIG. 7, the I/O device E400 connected to the PCI-Express slot 308a has been described as an example. However, this description also applies to other I/O devices F402 connected to other slots for example.

### (3) Routing Address 204a and PCI Express Slot 308

In the above example, a case was described in which the routing address 204a (e.g., “EEE”) and the PCI-Express slot 308a have a one-to-one correspondence. However, there are many cases where one device function as a plurality of I/O devices and a plurality of the routing addresses 204a are allocated to one PCI-Express slot 308.

For example, there may be a case where the routing addresses 204a “FFF” and “GGG” are both allocated to the PCI-Express slot 308b. In this case, the routing table 310a registers the following two entries:
FFF PCI-Express slot 308b and
GGG PCI-Express slot 308b.

As a result, the TLP having the routing address 204a “FFF” and the TLP having the routing address 204a “GGG” are both sent to the PCI-Express slot 308b.

7. Embodiment 2: Use of electronic device as I/O device

(1) Although the representation such as the I/O device E400 has been used, various I/O devices exist such as a keyboard, a mouse, a display, a hard disk, a manual tablet, or a joystick.

Various measurement devices also have been known as I/O device.

In recent years, I/O devices have been very sophisticated, including an I/O device to automatically perform various measurements to send the result to a computer. A camera including a motion detector function also exists that sends, when detecting a moving object, the image thereof to a computer.

As is clear from these examples, many I/O devices having high-performance and intelligent functions in recent years can be recognized as a computer.

Thus, an I/O device also may be preferably recognized as one electronic device (or one computer) and is to be communicated with as such.

(2) Routing unit 300 for the connection to external electronic device

As described above, an I/O device may be also preferably considered not as an I/O device to the computer but as the connection to an external electronic device. Thus, the above-described routing unit 300 can be also preferably considered as a routing unit to the external electronic device.

The term external electronic device means a computer including a CPU. The following description will be made based on an assumption that the external electronic device also includes an I/O device and a memory arranged based on predetermined address.

Even in such a case, the external electronic device is accessed from the CPU 100 based on an I/O instruction. Thus, from the program viewpoint, it is considered as an I/O device (or a memory).

### (3) Address Representation Method for the Case Where an External Electronic Device Exists (Integrated Address Representation Method)

However, when an address is represented including a case where an external electronic device is accessed, such an address representation method is preferred that considers the internal address of the external electronic device.

Thus, an address representation method as described below is suggested.

XXX@ZZZ

In this address, ZZZ means a routing address in this embodiment 2. It is noted that this is based on a afferent representation from that of the embodiment 1.

The routing address of this embodiment 2 shows an electronic device. For example, a unique address of an external electronic device is preferably used as an example. Furthermore, an own computer including the CPU 100 is also allowed to include a unique address as described above so that the address can be used as a routing address as in the external electronic device.

Specifically, this part “ZZZ” is preferably used to represent whether the address means an own computer or an external electronic device. It is noted that the routing address of the embodiment 2 is similar to the routing address of the embodiment 1 in that the address is physical data but the intended purpose thereof is slightly different from the latter.

The value of the part ZZZ is used to represent the following meanings for example,
000—Own computer (including the CPU 100)
111—The first external electronic device
222—The second external electronic device
333—The third external electronic device

On the other hand, the part XXX means the internal address of the destination (or the own computer) represented by the routing address and may be called as a so-called memory address.

Thus, the above-described XXX@ZZZ-type address representation method can be used to show which address in which electronic device is meant, thus providing an easy control of a plurality of electronic devices. Specifically, the following representation method is used.
ZZZ —which electronic device (routing address)

XXX—the internal address in the electronic device

Based on the representation XXX@ZZZ based on the representation method as described above, various addresses in a plurality of electronic devices (including own computer) can be accessed easily.

The representation as described above is particularly convenient because the representation can be used to clearly represent and recognize whether an external electronic device or an own computer is meant.

For example, the above XXX means the internal address of the computer given to the electronic device in the manner as described above (e.g., 32 bits, 64 bits). The predetermined address “ZZZ(=123)” represents the routing unit 300. The address in the electronic device is represented as “XXX(=456)”. Thus, this part XXX(=456) for example can be used to specify a predetermined register for example of an electronic device to be accessed.

The part ZZZ other than “000” on the other hand represents an external electronic device. Thus, the following address representation can be used.

XXX@ZZZ

This address representation can be used to clearly represent whether the device is a normal I/O device of the computer internal or an external electronic device, which is convenient.

The XXX part, i.e., the internal address in the electronic device (or the own computer (in the case where ZZZ=000 is set)) is preferably stored as the internal address 204b that is stored in the data portion 204 in TLP separately from the routing address 204a. How this is performed is shown in FIG. 8. This XXX part, i.e., the internal address 204b, is also preferably defined as a part of the routing address 204a in the data portion 204 in TLP.

Although FIG. 8 shows the routing address 204a followed by the internal address 204b, this order does not have any significant meaning. Specifically, another representation in which the internal address 204b is followed by the routing address 204a also may be used. These addresses may be stored at any position in the data portion 204.

According to a program using the representation method as described above, which address of which electronic device is a transmission destination can be clearly represented, thus allowing the program, to be prepared easily. Furthermore, according to a storage medium storing such a program, a program in this storage medium can be used to allow a computer to perform the above routing. Storage media include various optical discs such as DVDs, USB memory, and various other semiconductor memories and hard disks for example.

(4) In the above-described example, the part ZZZ means other electronic devices to be connected. However, the part ZZZ also can be configured to represent an own computer (in the ease where ZZZ=000 is set). In this case, the part ZZZ represents which electronic device is meant including itself. The part ZZZ can use an address unique to the electronic device or can have a different address.

For example, when the unique address of the electronic device is directly used, the following setting also can be used.
ZZZ=123—Own computer
ZZZ=1AB—First external electronic device
ZZZ=D4F—Second external electronic device
ZZZ=3FF—Third external electronic device
   (5) 7: Summary of embodiment 2

As described above, in this embodiment 2 a technique has been described and suggested by which, when the I/O device is another electronic device, the internal address of the another electronic device can be accessed.

8. Various Routing Addresses

As described above, the routing address 204a can have various length.

(1) MAC Address

For example, as a routing address, a Media Access Control address of an OSI reference model second layer or a data link, layer is also preferably used. This address, i.e., “M”media “A”access “C” control Address is frequently called as a“MAC” address based on these capital letters,

This MAC address may be represented as a Physical Address according to Windows® or may be called as a Node ID.

These MAC addresses are frequently added to an electronic device as an unique address. Thus, using these MAC address as a routing address is considered to be valuable.

Specifically, an address unique to the I/O device has been described as a routing address. A MAC address is preferably used as an example of the unique address.

A MAC address used in EtherNet for example is based on the format called EUI-48 (48 bits) and may be represented based on octet representation (e.g., 04-A3-43-5F-43-23).

(2) Use of EtherNet® Frame

When a MAC address is used as a routing address, an EtherNet® frame also may be preferably buried in a data portion. The reason is that the EtherNet® frame includes a MAC address.

FIG. 9 illustrates the outline of one example of an EtherNet frame 500. According to the example shown by this drawing, in EtherNet, a destination address 502 and a source address 504 are included and are a so-called MAC address (a unique 48 bit physical address of the device). These addresses and the type 506 art, combined to configure an Ethernet, header (14 bits). The type 506 field is frequently used as VLAN.

The EtherNet frame 500 is further composed of a data portion 208 (46 to 1500 bytes) and a CRC 210. However, the EtherNet frame 500 having a size up to about 8000 bytes is frequently used in recent years depending on the configuration type.

The EtherNet frame 500 generally includes two types of MAC addresses as described above. Thus, these addresses also can be preferably used as the routing address 204a and the internal address 204b, as shown in FIG. 8.

(3)

The above description has been made with regard to the use of the EtherNet frame 500. However, other frames including an address or a “packet” are also preferably used.

9. Address Term and Representation

As is well-known, a PCI-Express connecting port is frequently expressed or represented as an “internal slot” on the mother board of the interior of the housing of a computer. The PCI-Express connecting port may be referred to as an “expansion slot” or “expansion bus” due to this implication.

10. Summary, Modification, and Others

(1) In the example described above, a mechanism has been suggested through which a routing address is inserted to a data portion to thereby introduce a routing operation PCI-Express having no routing.

Although PCI-Express has been mainly described, the invention can be applied to any communication means or interface so long as the communication means or interface is an interface having no routing function, a P-P (Point-to-Point) interface, or a communication means using a frame inch:ding a data portion or a packet. Although the term “packet” is used in claims, a so-called frame or another one single piece of communication data corresponds to a preferred example of the “packet” of the invention and can be applied in the invention.

For example, the invention also can be applied to RS-232c for example. The invention also can be used for various communication specifications or codes having no routing function for example. For example, the invention is also preferably used for mobile communication or various communication specifications such as NFC.

(2) In the above-described embodiment, a mechanism has been described by which, when an I/O device connected to an own computer further has an internal address, the internal address of the I/O device is also specified and accessed.

For example, the above description applies to a case where the I/O device is substantially another computer. The use of this mechanism allows, when the I/O device (another computer) is further connected to an I/O device, an I/O device connected to the I/O device as the “another computer” to be accessed.

(2b) Multistage Connection

Furthermore, when an I/O device connected to “another computer” is substantially a computer and has an internal address, connection also can be made to “an I/O device connected to an I/O device (computer) connected to the another computer”.

In this case however, not only the routing address 204a but also two other addresses would be required. These addresses also must be stored in the data portion 204.

As described above, although so-called multistage connection can be achieved, a proportional increase of address(s) is required.

### DESCRIPTION OF THE REFERENCE NUMERALS

100 CPU
110 Route complex
120a, 120b, and 120c Switch
130a and 130b End point
134 End point
136 Bridge
140 I/O device A
142 I/O device B
144 I/O device C
200 TLP body
202 TLP header
204 Data portion (payload)
206 Sequence number
208 LCRC
210 Data link layer packet
214 Start frame
216 End frame
218 Physical layer packet
300 Routing unit
302 PCI-Express connector
304 Routing switch
306 Buffer memory
308a, 308b, 308c, and 308d PCI-Express slot
310 Memory
310e Routing table
400 I/O device E
402 I/O device F
404 I/O device H
406 I/O device H
500 Ethernet frame (EtherNet frame)
(÷MitherNet is a registered trademark.)
502 Destination address (MAC address)
504 Source address (MAC address)
506 Type
508 Data portion
510 CRC

1. A routing method of using a routing apparatus provided between a computer and other plurality of I/O devices to use a communication method for performing Point-to-Point communication to perform communication between the computer and the other plurality of I/O devices, comprising:
a step of allowing the computer to store a predetermined routing address in a data portion of a packet as a communication target of the communication method to send the packet; and
a step of allowing the routing apparatus to extract the routing address in the sent packet to send the packet to the I/O device as a destination shown by the routing address.

2. The routing method according to claim 1, wherein:
the routing address is an address unique to the I/O device.

3. The routing method according to claim 1, wherein:
the routing address is an address allocated by the computer to the I/O device.

4. A program for allowing the routing method according to claim 1 to be executed by the computer, wherein:
the address of the I/O device is described as XXX@YYY, wherein the XXX means the routing address and the YYY means the address of the routing apparatus in the computer.

5. A storage medium storing therein a program for allowing the routing method according to claim 1 to be executed by the computer, wherein in the program:
the address of the I/O device is described as XXX@YYY, wherein the XXX means the routing address and the YYY means the address of the routing apparatus in the computer.

6. A routing method of using a routing apparatus provided between a computer and other plurality of electronic devices to use a communication method for performing Point-to-Point communication to perform communication between the computer and the other plurality of electronic devices, comprising:
a step of allowing the computer to store, in a data portion of a packet as a communication target of the communication method, a routing address showing a target electronic device as a communication partner and an internal address of the target electronic device to send the packet; and
a step of allowing the routing apparatus to extract the routing address in the sent packet to send the packet including an internal address of the target electronic device to the target electronic device as a destination shown by the routing address.

7. A program to allow the computer to execute the routing method according claim 6, wherein:
an address in the target electronic device is described as XXX@ZZZ, wherein the ZZZ means the routing address showing the target electronic device and the XXX means an internal address in the target electronic device.

8. A storage medium storing therein a program for allowing the computer to execute the routing method according to claim 6, wherein in the program:
an address in the target electronic device is described as XXX@ZZZ, wherein the ZZZ means the routing address showing the target electronic device and the XXX means an internal address in the target electronic device.

9. A computer system, comprising:
a computer;
a routing apparatus connected to the computer; and
one or more I/O devices connected to the routing apparatus,
wherein:
the routing apparatus includes:
a connector for providing the connection to the computer by a Point-to-Point communication method;
a plurality of slots that may be connected to the I/O devices; and
a routing switch for extracting a routing address stored in a data portion of a packet as a communication target of the communication method sent from the computer via the connector to send the packet to the slot specified by the routing address, wherein:
when the computer stores the routing address in a data portion of a packet as a communication target of the communication method and sends the packet to the routing apparatus via the connector, then the routing apparatus extracts the routing address stored in the data portion of the packet as a communication target of the communication method and sends the packet to the slot specified by the routing address.

10. The computer system according to claim 9, wherein:
the routing apparatus includes a routing table recording a correspondence relation between the routing address and a slot number corresponding thereto, and
the routing switch searches a routing address in the packet from the routing table to determine, based on the found correspondence relation, the slot number to be sent and sends the packet to a slot having the determined number.

11. The computer system according to claim 10, wherein:
the routing switch reads, when the any slot is connected to the I/O device, an address unique to the I/O device from the I/O device to register, in the routing table, the unique address and the slot number connected to the I/O device, and
the routing switch uses the unique address as a routing address.

12. A method of storing the correspondence relation in the routing table in the computer system according to claim 10, wherein:
the method comprises:
a step of allowing the routing switch to read, when the any slot is connected to the I/O device, an address unique to the I/O device from the I/O device and registers, in the routing table, the unique address and the slot number connected to the I/O device, the routing switch using the unique address as a routing address.

13. The computer system according to claim 10, wherein:
the routing switch allocates, when the any slot is connected to the I/O device, a predetermined address to the I/O device to register, in the routing table, the allocated address and the slot number connected to the I/O device, and
the routing switch uses the allocated address as a routing address.

14. A method of storing the correspondence relation in the routing table in the computer system according to claim 10, wherein:
the method comprises:
a step of allowing the routing switch to allocate, when the any slot is connected to the I/O device, a predetermined address to the I/O device to register, in the routing table, the allocated address and the slot number connected to the I/O device, the routing switch using the allocated address as a routing address.

15. The routing apparatus used in the computer system according to claim 9, comprising:
a connector for providing the connection to the computer by a Point-to-Point communication method;
a plurality of slots that may be connected to the I/O devices; and
a routing switch for extracting a routing address stored in a data portion of a packet as a communication target of the communication method sent from the computer via the connector to send the packet to the slot specified by the routing address,
wherein:
when the computer stores the routing address in a data portion of a packet as a communication target of the communication method and sends the packet to the routing apparatus via the connector, a routing address stored in the data portion of the packet as a communication target of the communication method is extracted and the packet is sent to the slot specified by the routing address.

16. The routing apparatus according to claim 15, further comprising:
a routing table recording a correspondence relation between the routing address and a slot number corresponding thereto,
wherein:
the routing switch searches a routing address in the packet from the routing table to determine, based on the found correspondence relation, the slot number to be sent and sends the packet to a slot having the determined number.
